(19) United States
(12) Patent Application Publication
(10) Pub. No.: US 2003/0012020 A1
(43) Pub. Date: Jan. 16, 2003

(54) PAD LOCK ILLUMINATION DEVICE

(76) Inventor: Peter C. King, Alameda, CA (US)

Correspondence Address: Robert S. Smith, 1263 EMORY ST, San Jose, CA, 95126, US

(21) Appl. No.: 09/905,843

(22) Filed: Jul. 14, 2001

(51) Int. Cl. F21V 33/00

(52) U.S. Cl. 362/234; 362/253; 362/109; 362/802

(57) ABSTRACT

A light assembly for a padlock including a housing that snaps onto said padlock and having a notch that engages a fixed leg of the shackle of the lock and a hole through which the free leg of the shackle extends when it enters the case of the padlock. This arrangement prevents pilfering the device when the lock is closed. A battery, switch and LED lamp are encased by plastic molding into the housing wall. The light is positioned to illuminate the keyhole area or tumbler area of the lock. The device is adaptable to either a otart or tumbler style combination padlock.

### FIELD OF THE INVENTION

This invention relates to lights that aid in unlocking locks in the dark and particularly to a light that illuminates the tumbler dials or keyhole of a padlock.

### PRIOR ART AND INFORMATION DISCLOSURE

The typical padlock has a case with a shackle on one side and either a keyhole or row of tumbler dials on an opposite side. The combination lock is unlocked by aligning the tumbler dials according to a combination of numbers that is special for that lock and known only to the user of the lock. The rotations align the tumblers so that the lock is thereby unlocked. The value of this type of lock is that no key is required that might be lost or duplicated.

A problem with the padlock is that, when it is used in a darkened area, the user has difficulty unlocking the lock because he cannot see the keyhole or dial numbers. Such a situation exists, for example, on board a ship where lights in the berthing compartment are left off almost constantly because there are always people sleeping on different shifts. Under this circumstance, the owner of the lock needs a flashlight in order to unlock his lock.

The necessity to carry a flashlight simply to unlock a padlock is an inconvenience.

The use of lights has been disclosed in the lock art.

For example, U.S. Pat. No. 5,611,226 to Fata discloses a light illuminating the key hole positioned in a doorknob. The light assembly comprises a watch battery and LED.

U.S. Pat. No. 5,597,227 discloses an illumination system that illuminates the keyhole before the user inserts the key.

U.S. Pat. No. 3,793,565 discloses a plastic card with polarized lenses and illuminating means for opening a combination lock.

U.S. Pat. No. 5,730,013 to Huang discloses a light mounted on a key structure.

None of these examples of the prior art address the present problem which is how to avoid the necessity of carrying a portable light in anticipation of being required to open a combination lock in the dark or how to provide a light that is always available when it is required to unlock the lock, need not be carried on the person, may not be stolen off the lock, is usable with existing padlocks.

### SUMMARY OF THE INVENTION

It is an object of this invention to provide a light assembly that is attachable to an existing padlock that illuminates the dial of the lock to aid in setting the combination.

It is another object that the assembly of this invention be mountable on locks that are presently in use thereby avoiding the necessity of the user to having to buy himself a special lock intended for use of the invention.

It is another object to provide a light assembly that is constructed in a manner that enables a user to mount the assembly on the lock when the lock is in the unlocked condition but cannot be removed when the lock is in the locked condition thereby preventing theft of the light assembly when it is unattended.

This invention is directed toward a housing enclosing a light assembly. The light assembly includes a series connection of a lamp (preferably an “ultra bright” LED), a switch (preferably a momentary on, the type that is closed when squeezed) and a battery (preferably a “watch” battery). The housing is constructed to fit onto the padlock in common use in which the shackle is a U bar having one “fixed” leg permanently engaged in a lock case and another “free” leg that slides into a hole in the case when it is required to lock the lock. One side of the housing has a notch and an aperture separated from one another by the distance between the legs of the shackle. The housing “snaps” around the lock casing with the fixed leg engaging the the notch and the free leg extending through the aperture and thereby positions the light to illuminate the keyhole or row of tumbler dials of the padlock.

### BRIEF DESCRIPTION OF THE DRAWINGS

FIG. 1 shows a typical padlock to which the invention applies with the light assembly of this invention poised for mounting on the padlock.

FIG. 2 is a perspective view of the light assembly of this invention mounted on the padlock.

FIG. 3 is a side view of the light assembly mounted on the lock.

FIG. 4 shows an embodiment of the invention poised for clipping onto a combination padlock having a rotary dial

FIG. 5 shows the light assembly of this invention clipped onto a padlock having a rotary dial.

### DESCRIPTION OF THE PREFERRED EMBODIMENT

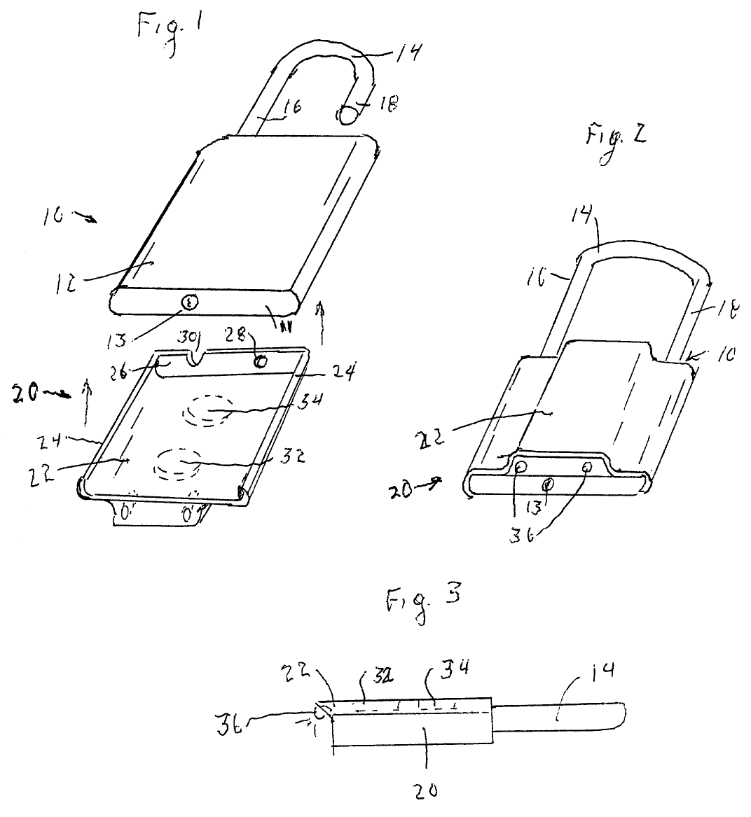

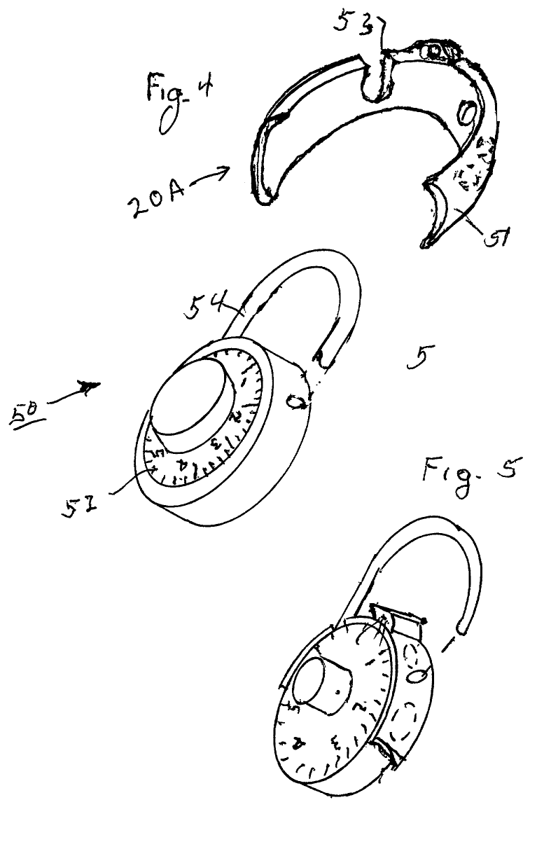

Turning now to a description of a preferred embodiment, FIG. 1 shows the typical padlock 10 with a case 12 and a U shaped shackle 14 having one “fixed” leg 16 swivally secured in the case and another “free” leg 18 that swings away from the case to permit installing the lock 10. The light assembly 20 of this invention is shown poised for mounting on the padlock 12 in FIG. 1 and is shown mounted and attached on the lock in FIG. 2. FIG. 3 is a side view of the light assembly secured on the padlock 10. The light assembly 20 comprises a housing including a panel 22 having opposite edges with two parallel lips 24, each lip being convex toward the center of the panel 22 and dimensioned so that the housing clips onto the case 12 of the padlock 10 with the panel 22 against the broad side of the case 12 and the convex lips 24 embracing the case 12 A side panel 26 has one edge extending perpendicularly away from an edge of the panel 22. The side panel 26 has one aperture 28 and an open notch 30 spaced from one another by the space equal to between the distance between the legs of the shackle 14. This provides that the housing of the light assembly 20 can be snapped onto the case 12 of the lock 10 with the permanently swivally attached leg 16 fitted into the notch 16 and the other “free” leg 18 extending through the aperture 28 when the padlock 12 is closed. this arrangement ensures that the light assembly 22 cannot be separated (stolen) from the padlock 10 when the padlock 10 is locked.

The housing is preferably a molded plastic body with a pressure switch 32 and watch battery 34 encased in the panel 22 preferably by injection molding. The switch 32 and battery 34 are shown in phantom in FIGS. 1 and 2. A pair of ultra bright LEDs 36 (connected in series with switch 32 and battery 34) are also encased in the panel 22 and the lights 36 are positioned at the edge of the panel 22 so that the side 11 of the lock holding either the array of combination tumblers 13 or a key hole (not shown) are illuminated when the lights 36 are energized by pressing switch 34.

FIG. 4 shows another embodiment of the invention in which the light assembly 20A is poised for mounting onto a combination padlock 50 of the type having a rotary dial. 52. The housing of the light assembly 20A is a partial cylindrica shell 51 having the notch 53 for engaging the fixed leg 54 of padlock 50.

There has been described a light assembly including a switch-lite-battery circuit all encased into a housing. The light assembly is preferably made of a moldable plastic that has elastomeric properties so that the housing clips onto a padlock. A major advantage of the light assembly is that it is separable from the lock when the lock is unlocked. Therefore the device can be purchased separately from the lock and mounted on an existing lock. When the light assembly is mounted onto the lock and the lock is closed, the light assembly can not then be separated (stolen) off the lock.

The light assembly including the lamp, switch, battery and the housing can all be integrally joined together by an injection molding process.

Modification and variations of the device may be contemplated suggested by reading the specification and studying the drawings which are within the scope of the invention. I therefore wish to define the scope of my invention by the appended claims.

I claim:

1. A light assembly attachable to a padlock, said padlock having a case, a shackle with one fixed leg (16) swivally secured in one side of the case (12) and a free leg (18) lockably insertable into a hole in said one side of the case,
a housing clippable onto said case and partially enclosing said case;
said housing having a notch arranged to engage said fixed leg when said housing partially encloses said case;
said housing having an aperture positioned to permit extending an end of said free leg through said aperture and into said case whereby said padlock is locked and said housing is secured to said padlock;
a light circuit including a lamp, battery and switch connected in series and integrally joined to said housing;
said lamp arranged to illuminate an area of said case when said switch is closed.

2. The light assembly of claim 1 wherein said padlock is the type having one of a keyhole area and a tumbler area of said case on a side of the case opposite the shackle, said housing comprising:
a panel (22) attached to three sides;
two sides of said three sides being two parallel lips (24) convex toward a center of said panel;
a third side (26) of said three sides having an elongated edge joined to said panel along an edge of said panel and extending perpendicularly away from said panel;
said third side having one end edge joined to an end of one said lip and another end edge joined to one end edge of said other lip;
said aperture (28) and said open notch (30) being formed in said third side and operably arranged to permit said light assembly (20) to be snapped onto the lock case (12) with the fixed leg (16) fitted into said notch (16) and the free leg (18) extending through said aperture (28) when the padlock (12) is closed; and
said lamp, battery and switch all integrally joined to said back panel wherein said lamp lights when said switch is closed and illuminates said one of said keyhole area and said tumbler area.

3. The light assembly of claim 1 wherein said battery is an ultra bright LED.

4. The light assembly of claim 1 wherein said lamp, battery and switch are integrally joined to said panel by plastic molding.

5. The light assembly of claim 1 wherein said switch is a momentary on switch that is closed by squeezing said light assembly mounted on said lock.

6. The light assembly of claim 1 wherein said padlock is a combination padlock of the type having a cylindrical case bounded by two flat sides parallel to one another and a cylindrical surface with a a rotary dial mounted on one of said flat sides of said case, said housing comprising:
a shell having a partial cylindrical shape contoured to fit concentrically around said cylindrical case
said aperture (28) and said open notch (30) being formed in said shell;
said lamp being arranged to illuminate an area of said dial.

7. The light assembly of claim 6 wherein said shell is made of plastic formulated to have resilient properties.
